(19) United States
(12) Patent Application Publication
(10) Pub. No.: US 2025/0267147 A1
(43) Pub. Date: Aug. 21, 2025

(54) EFFICIENT CLEARING TECHNIQUES

(71) Applicant: Visa International Service Association, San Francisco, CA (US)

(72) Inventor: Millie Ling Yee, Santa Clara, CA (US)

(73) Assignee: Visa International Service Association, San Francisco, CA (US)

(21) Appl. No.: 19/059,204

(22) Filed: Feb. 20, 2025

Related U.S. Application Data
(60) Provisional application No. 63/556,181, filed on Feb. 21, 2024.

(51) Int. Cl. H04L 9/40

(52) U.S. Cl. CPC H04L 63/10

(57) ABSTRACT

Techniques include receiving an authorization request message for an interaction by a processor server computer, the authorization request message comprising interaction data comprising an interaction amount, and transmitting the authorization request message to an authorization computer. The processor server computer receives an authorization response message from the authorization computer indicating that the interaction is approved. Based on the interaction data, an indicator, indicating a likelihood that the interaction amount in the authorization request message will equal a clearing amount for the interaction, is generated along with a modified authorization response message comprising the indicator. The processor server computer transmits, to the resource provider computer, the modified authorization response message. The processor server computer generates a clearing message based on the indicator and at least a subset of the interaction data and transmits the clearing message, thereby causing clearing and settlement of the interaction.

### CROSS-REFERENCES TO RELATED APPLICATIONS

This is a non-provisional application, which claims priority to U.S. Provisional Application No. 63/556,181 filed on Feb. 21, 2024, which is herein incorporated by reference in its entirety.

### BACKGROUND

Today, in the dual message card processing ecosystem, entities can operate in a real-time authorization plus batch-based clearing and settlement flow environment, with separate processes of authorization, clearing, settlement, and funding. A transaction is only considered complete when it is authorized, cleared, and settled. The clearing phase is often operational, delayed, and outdated, which presents integrity and logical loopholes. Uncertainty delays the clearing, which requires additional workload from the various computing devices involved. While authorization happens in real-time, clearing can take several days, causing undesirable lags in transaction processing.

Embodiments of the disclosure address this problem and other problems individually and collectively.

### SUMMARY

Embodiments are directed to efficient transaction clearing systems and methods that implement machine learning to select and apply the appropriate clearing mechanism.

In some embodiments, a method comprises receiving, by a processor server computer from a transport computer, an authorization request message for an interaction, the authorization request message comprising interaction data comprising an interaction amount; transmitting, by the processor server computer, the authorization request message to an authorization computer; receiving, by the processor server computer from the authorization computer, an authorization response message indicating that the interaction is approved; based on the interaction data, generating, by the processor server computer, an indicator, wherein the indicator indicates a likelihood that the interaction amount in the authorization request message will equal a clearing amount for the interaction; generating, by the processor server computer, a modified authorization response message comprising the indicator; transmitting, by the processor server computer to the transport computer, the modified authorization response message; generating, by the processor server computer, a clearing message based on the indicator and at least a subset of the interaction data; and transmitting, by the processor server computer to the authorization computer or the transport computer, the clearing message, thereby causing clearing and settlement of the interaction.

In some aspects, the clearing of the interaction is performed in less than an hour from transmitting the modified authorization response message.

In some aspects, the indicator is generated using a machine learning model trained to predict the likelihood that the interaction amount in the authorization request message will equal the clearing amount for the interaction. In some aspects, the method further includes training the machine learning model using historical interaction data. In some aspects, the machine learning model comprises a multi-task learning model having a plurality of layers.

In some aspects, the processor server computer transmits the clearing message to both the authorization computer and the transport computer.

In some aspects, the method further comprises determining, based on the interaction data, that the transport computer is enrolled in a program before generating the indicator, wherein generating the indicator, generating the modified authorization response message comprising the indicator, and generating and transmitting the clearing message are performed responsive to determining the enrollment.

In some aspects, a system (e.g., a processor server computer) comprises one or more processors; and one or more computer readable media comprising code executable by one or more processors to perform any of the above methods.

In some embodiments, a method comprises transmitting, by a transport computer to a processor server computer, an authorization request message for an interaction, the authorization request message comprising interaction data comprising an interaction amount; receiving, by the transport computer from the processor server computer, an authorization response message indicating that the interaction is approved, the authorization response message further comprising an indicator, generated using a machine learning model, which indicates a likelihood that the interaction amount in the authorization request message will equal a clearing amount for the interaction; receiving, by the transport computer, a clearing notification based on the indicator and at least a subset of the interaction data; and transmitting, by the transport computer to a computing device, at least a subset of the clearing message, thereby causing updating of the machine learning model.

In some aspects, the interaction is thereafter cleared in less than an hour from receiving the authorization response message. In some aspects, the machine learning model is a neural network trained to predict the likelihood that the interaction amount in the authorization request message will equal the clearing amount for the interaction.

In some aspects, the method further comprises refraining from generating the clearing message based on the indicator. In some aspects, wherein the processor server computer generates the clearing message based on the indicator.

In some aspects, the method further comprises providing, to the processor server computer, configuration data configuring enrollment in a program, wherein receiving the indicator and generating the clearing message based on the indicator and at least a subset of the interaction data are performed responsive to providing the configuration data.

These and other embodiments are described in further detail below.

### BRIEF DESCRIPTION OF THE DRAWINGS

FIG. 1 shows a process flow of a traditional clearing and settlement process.

FIG. 2 shows a process flow of a clearing and settlement process using a clearing model according to various embodiments.

FIG. 3 shows an example processor server computer according to various embodiments.

FIG. 4 shows an example transport computer according to various embodiments.

FIG. 5 shows an example of systems and techniques for training and applying a clearing model according to various embodiments.

### DETAILED DESCRIPTION

Prior to discussing embodiments of the disclosure, some terms can be described in further detail.

A “resource provider” may be an entity that can provide a resource such as goods, services, information, and/or access. Examples of resource providers include merchants, data providers, transit agencies, governmental entities, venues, and dwelling operators, etc.

A “merchant” may typically be an entity that engages in transactions and can sell goods or services, or provide access to goods or services.

A “resource provider” may be an entity that can provide a resource such as goods, services, information, and/or access. Examples of resource providers include merchants, data providers, transit agencies, governmental entities, venue and dwelling operators, etc. A “merchant” may typically be an entity that engages in transactions and can sell goods or services or provide access to goods or services.

A “resource provider computer” may be a computer operated by a resource provider. Suitable computers may include access devices, back-end server computers, as well as combinations of the above.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer.”

An “authorizing entity” may be an entity that authorizes a request. Examples of an authorizing entity may be an issuer, a governmental agency, a document repository, an access administrator, etc.

An “issuer” may typically refer to a business entity (e.g., a bank) that maintains an account for a user. An issuer may also issue payment credentials stored on a user device, such as a cellular telephone, smart card, tablet, or laptop to the consumer.

“Clearing” may be a process in which a transport computer (e.g., operated by an acquirer) exchanges transaction information with an authorizing entity computer (e.g., operated by an issuer). After successful reconciliation, the transport computer generates a clearing file for various schemes (e.g., payment card networks). These schemes then break down these files into records and process them. The records are sent to various authorizing entity computers for settlement.

A “server” or “server computer” may include a powerful computer or cluster of computers. For example, the server can be a large mainframe, a minicomputer cluster, or a group of servers functioning as a unit. In one example, the server may be a database server coupled to a Web server. The server may comprise one or more computational apparatuses and may use any of a variety of computing structures, arrangements, and compilations for servicing the requests from one or more client computers.

A “processing system” may include a network of one or more devices that can process and route transaction request messages. An example of a processing system may include data processing subsystems, networks, and operations used to support and deliver authorization services, exception file services, transaction scoring services, and clearing and settlement services. An example of a processing system is VisaNet™. Transaction processing systems such as VisaNet™ are able to process credit card transactions, debit card transactions, and other types of commercial transactions. VisaNet™, in particular, may include a VIP system (Visa Integrated Payments system) which processes authorization requests, and a Base Il system which performs clearing and settlement services. A processing system may operate one or more “processor server computers.”

An “authorization request message” may be an electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a username, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g., POS equipment) that indicates approval of the transaction. The code may serve as proof of authorization.

A “settlement message” can include an electronic message used to initiate the transfer of funds from an issuer to an acquirer, the funds being associated with an electronic payment transaction conducted at a merchant having a relationship with the acquirer. A settlement message according to some embodiments may comply with ISO 8583. Settlement can be initiated by a merchant, acquirer, gateway, or other suitable payment processing entity. Settlement messages can be generated and transmitted to a payment processing network and/or issuer periodically (e.g., daily) or sporadically. In some embodiments, a payment processing network can facilitate the transmission of a settlement message and an exchange of funds. For instance, upon receipt of a settlement message, a payment processing network can transmit the settlement message to an issuer. Funds can be transferred from the issuer to a settlement account designated by the payment processing network which can direct the funds from the settlement account to the acquirer which may deposit the funds (minus any fees owed to the acquirer) in a merchant account.

An “interaction” can be a reciprocal action, effect, or influence. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment. An interaction may involve the exchange of monetary funds or the exchange of goods or services for monetary funds between two individuals or entities.

“Interaction data” may include any suitable information associated with an interaction between an access device and a user device. Interaction data may include any suitable data associated with an interaction (e.g., a purchase transaction.). In some embodiments, interaction data may include any suitable combination of: identification data associated with an access device (e.g., one or more identifiers of an access device), identification information associated with a user device (e.g., one or more identifiers associated with a user device), an interaction value (e.g., a transaction amount such as a preauthorization amount and/or purchase price of a transaction), payment data (e.g., a payment account identifier associated with a payment account), one or more locations each associated with an access device and/or a user device, or any suitable information. Examples of payment data may include a PAN (primary account number or “account number”), user name, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment data may be any information that identifies or is associated with a payment account. Payment data may be provided in order to make a payment from a payment account. Payment data can also include a user name, an expiration date, a gift card number or code, and any other suitable information. Interaction data may relate to ticket information for an event, data to access a building, transit ticket information, passwords, biometrics, or other credentials to access secure data, etc.

The term “artificial intelligence model” or “AI model” may refer to a model that may be used to predict outcomes in order to achieve a target goal. The AI model may be developed using a learning algorithm, in which training data is classified based on known or inferred patterns. An AI model may also be referred to as a “machine learning model.”

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on a “feature vector” or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines, models that classify data by establishing a gap or boundary between inputs of different classifications, as well as neural networks, collections of artificial “neurons” that perform functions by activating in response to inputs.

A transaction can be initiated when a user provides payment to a resource provider (e.g., merchant). For example, the user can make a purchase from a resource provider using a credit card. The resource provider operates a resource provider computer, which then forwards the user's payment information (e.g., via a transport computer and a processing network) in an authorization request message to an authorizing entity computer (e.g., operated by an issuer) for authorization. During authorization, the authorizing entity computer decides whether the transaction is approved or declined in real time and posts the authorization decision. The authorizing entity computer checks that the user is allowed to conduct the transaction and has sufficient funds available in their account. If the transaction is approved, the resource provider grants the user access to an item or good.

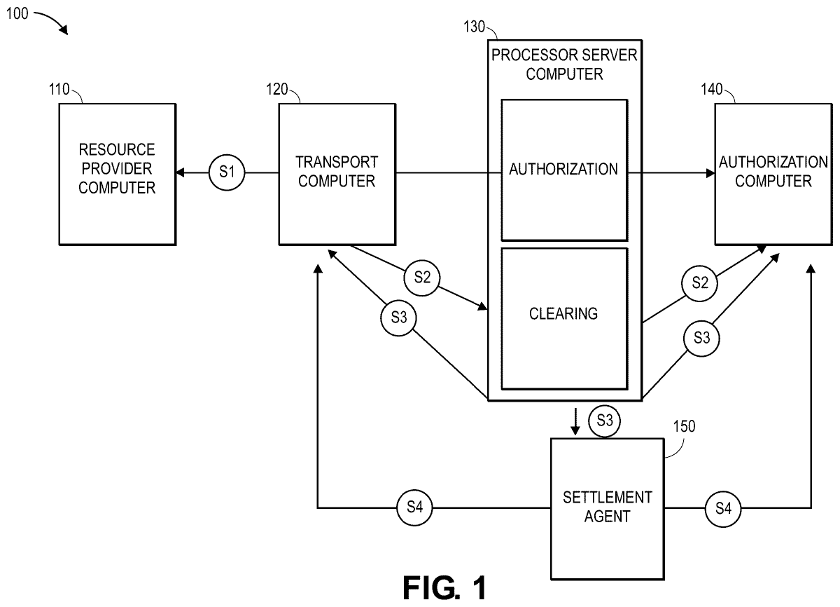

FIG. 1 shows a process flow of a traditional clearing and settlement process. The clearing and settlement process 100 is performed in a system including a resource provider computer 110, a transport computer 120, a processor server computer 130, and an authorization computer 140. The system can further include a settlement agent 150. For simplicity of illustration, a limited number of components are shown in FIG. 1. It is understood, however, that embodiments may include more than one of each component. The components in the system depicted in FIG. 1 can be in operative communication with each other through any suitable communication channel or communications network.

The resource provider computer 110 may be associated with a resource providing entity such as a merchant, service provider, or a secure location. The resource provider computer 110 may receive, transmit, and analyze messages such as authorization request messages, authorization response messages, and interaction request messages. The resource provider computer 110 may generate settlement requests to request funds for resources provided. The resource provider computer 110 may be connected to the transport computer 120.

The transport computer 120 may be associated with the resource provider computer 110 and may manage requests (e.g., interaction requests and authorization requests) on behalf of the resource provider computer 110. In some embodiments, the transport computer 120 may be operated by an acquirer.

The processor server computer 130 may include functionality to process an interaction. The interaction processing functions performed by the processor server computer 130 can include authorization operations and clearing operations, as illustrated in FIG. 1.

The authorization computer 140 may be a system associated with an issuer or entity (e.g., a bank) that has a business relationship with a processor server computer 130 or other entity. In some embodiments, the authorization computer 140 is configured to determine whether a particular interaction should be authorized.

The settlement agent 150 is an entity associated with a computing device configured to perform settlement services such as managing the settlement process and/or submitting settlement files.

In step S1, authorization is performed. Authorization may include the resource provider computer 110 generating and transmitting an authorization request message to the transport computer 120, which forwards the authorization request message to the processor server computer 130, which forwards the authorization request message to the authorization computer 140. The authorization computer 140 determines whether to authorize the transaction and, based on this determination, sends an authorization response message back to the resource provider computer 110 via the processor server computer 130 and transport computer 120. Authorization can be performed substantially immediately, i.e., in a matter of seconds.

In some instances, if the transaction is authorized, the authorization computer 140 places a temporary hold on the user's account. To the user, their available credit balance will be reduced by the hold amount, and they will see a “pending transaction” on their account. The amount of the hold is usually the same as the authorization amount except for some special cases such as in the hotel and fuel merchant categories. The hold lasts until the authorization computer 140 officially posts the transaction to the user's account during clearing (e.g., as long as 7 days or more depending on the type of transaction).

In step S2, clearing is performed. The clearing process may include collecting transaction information from one entity and delivering it to another. For example, clearing involves the submission of a clearing draft from the transport computer 120. Data in the clearing draft can be used by the entities associated with the transport computer 120, authorization computer 140, and/or processor server computer 130, to make entries to their accounting and general ledger systems. Clearing may further include transaction valuation. In a dual-message clearing process, the transport computer 120 creates a clearing draft, which is stored in a batch until the batch is processed, which may occur in one or more days. The typical timeframe to submit the clearing draft ranges from the same day up to three or more days.

Clearing enables verification of transaction data, which is important for fraud and chargeback prevention. In batch transaction processing, the clearing process occurs separately from authorization. The resource provider may collect all the transactions from that day, and send them to a transport computer (e.g., operated by an acquirer bank) to distribute to the respective authorizing entities for clearing.

In step S3, settlement is performed. The settlement process may include calculating the net financial settlement position for all cleared transactions and creating settlement reports for delivery. Clearing at step S2 and settlement at step S3 typically occur on the same day.

In step S4, funding is performed. Settlement at step S3 and funding at step S4 may not occur on the same day. Acquirers typically fund their merchants after they receive settlement reporting and funds from the payment network. Typically, this process can take 3-30 days, and money is not received as quickly as would be desired. Thus, the payment network's ability to deliver immediacy is constrained by the current processes and dependencies.

Thus, in traditional interaction processing schemes, certain determinations may be based on multiple pieces of information that may be received at different times. For example, a payment transaction may be a dual-message transaction, in which at least one first message (e.g., authorization request, authorization response, and/or the like) is communicated at the time of the payment transaction, and at least one second message (e.g., clearing message, settlement message, and/or the like) is communicated at a later point in time (e.g., at the end of the day, one day later, multiple days later, and/or the like). Certain systems, such as that associated with the authorization computer 140, may not post a transaction to an account until after the second message is communicated. This can lead to delays, inaccuracies (e.g., inaccurate determinations of available funds), reduced transparency, and inconsistencies.

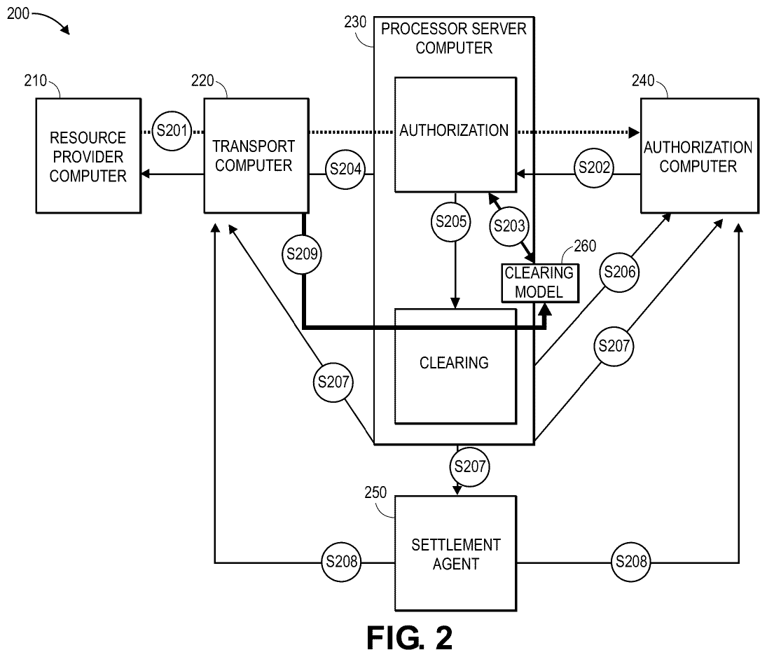

FIG. 2 shows an example system 200 and flow for performing a clearing and settlement process using a clearing model according to various embodiments. The system 200 can comprise one or more computers associated with a processor server computer 230 and clearing model 260. The system 200 may further include a resource provider computer 210, an authorization computer 240, and a transport computer 220. For simplicity of illustration, a limited number of components are shown in FIG. 2. It is understood, however, that embodiments may include more than one of each component.

The components in the system depicted in FIG. 2 can be in operative communication with each other through any suitable communication channel or communications network. Suitable communications networks may be any one and/or the combination of the following: a direct interconnection; a short-range communication protocol; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between computers, networks, and devices may be transmitted using secure communications protocols such as, but not limited to, Secure File Transfer Protocol (SFTP); Secure Hypertext Transfer Protocol (HTTPS), Secure Socket Layer (SSL), ISO (e.g., ISO 8583) and/or the like.

The resource provider computer 210, transport computer 220, processor server computer 230, authorization computer 240, and settlement agent 250 may be similar to the resource provider computer 110, transport computer 120, processor server computer 130, authorization computer 240, and settlement agent 150 described above with respect to FIG. 1.

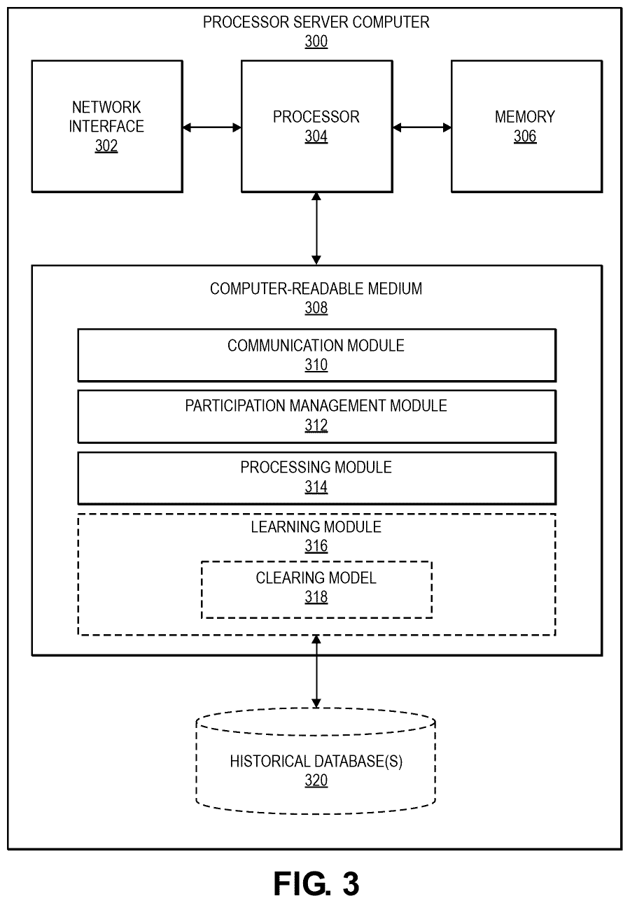

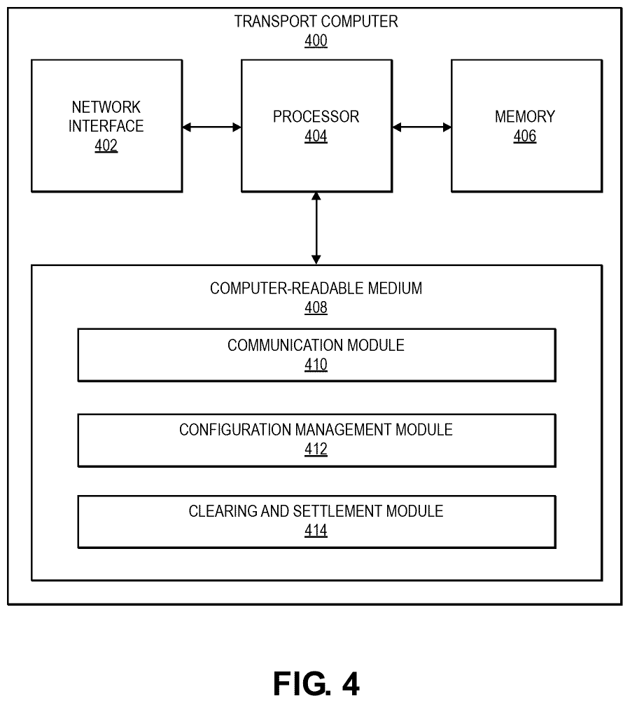

The transport computer 220 and the processor server computer 230 may differ from those of FIG. 1 in that they are configured to handle clearing files based on predictive information generated by the clearing model 260, as described herein. An example of a suitable processor server computer is described below with respect to FIG. 3, and an example of a suitable transport computer is described below with respect to FIG. 4.

The clearing model 260 may be part of, or communicatively coupled to, the processor server computer 230. The clearing model 260 may include one or more machine learning models. In some implementations, the clearing model 260 may include at least one Multi-Task Learning (MTL) model. The clearing model 260 may include one or more of a Deep Neural Network (DNN), an MTL model, or any combination thereof. The clearing model 260 may be configured to perform tasks such as generating predictions related to an interaction.

Initially, an interaction (e.g., transaction) is initiated at a resource provider computer 210. In step S201, the resource provider computer 210 generates and transmits an authorization request message. The authorization request message includes interaction data (e.g., an interaction amount, resource provider identifier, account identifier, and associated account information, etc.). The resource provider computer 210 transmits the authorization request message to the transport computer 220, which forwards the authorization request message to the processor server computer 230. The processor server computer 230 receives, from the resource provider computer 210, the authorization request message. The processor server computer transmits the authorization request message to the authorization computer 240.

The authorization computer 240 receives the authorization request message and analyzes the interaction data therein. The authorization computer 240 determines whether to approve or decline the interaction based on the interaction data.

The authorization computer 240 generates an authorization response message indicating whether the interaction is approved or declined.

In step S202, the authorization computer 240 transmits the authorization response message to the processor server computer 230. In the case that the interaction is approved, the response indicates that authorization is approved, as shown in FIG. 2.

The processor server computer 230 receives, from the authorization computer 240, the authorization response message. In some aspects, the processor server computer 230 determines whether the interaction is approved based on the authorization response message. For example, the processor server computer 230 inspects the contents of an authorization result field of the authorization response message to determine whether the interaction is approved.

In some implementations, the processor server computer 230 may determine whether the acquirer associated with the transport computer 220 is participating in the specialized clearing scheme described herein (i.e., determine that the transport computer is enrolled in a program). Acquirers may opt in or out of the process. For example, acquirers can configure participation based on configuration data corresponding to key fields in the authorization messages, such as merchant identifier, Merchant Category Code (MCC), acquirer identifier and/or the like. The processor server computer 230 may store a table including the acquirer configuration details used to identify participating acquirers. The processor server computer 230 may check for acquirer participation (acquirer identifier, merchant category code/identifier) in the response leg of approved authorizations.

Thus, the processor server computer 230 may determine, based on the interaction data, that the transport computer is enrolled in a program before generating the indicator. Subsequent steps such as generating the indicator, generating the modified authorization response message comprising the indicator, and generating and transmitting the clearing message may be performed responsive to determining the enrollment. In the case in which an acquirer does not wish to participate, the clearing and settlement can proceed in a similar fashion as described above with respect to FIG. 1.

If the acquirer is participating and the interaction is approved, then the processor server computer 230 proceeds to step S203. If the acquirer is not participating and/or the interaction is not approved, then the processor server computer may skip step S203 and transmit the authorization response message to the resource provider computer 210 as it is received.

In step S203, based on the interaction data, the processor server computer 230 determines the likelihood that the interaction amount in the authorization request message will equal a clearing amount for the interaction. In some instances, determining such a likelihood includes the processor server computer 230 invoking the clearing model 260. The clearing model 260 is configured to generate an indicator or score indicating a likelihood that the amount in the authorization request message will be the same as the ultimate clearing amount.

As noted above, the clearing model 260 may include one or more machine learning models. Such a machine learning model may be trained to predict the likelihood that the interaction amount in the authorization request message will equal the clearing amount for the interaction. Alternatively, or additionally, the clearing model 260 may be a rules-based model or any suitable model. For example, for certain merchant categories, the score may be set to a certain value or based on a certain algorithm.

In some aspects, the clearing model 260 can extract relevant feature data from one or more historical databases and use the extracted feature data to produce a matched profiling score indicating the likelihood that the clearing amount will equal the authorization amount. The historical databases may include short-term authorization data, long-term authorization data, short-term clearing data, and long-term clearing data.

In some aspects, the clearing model 260 uses input extracted from the authorization request message, such as a resource provider identifier, resource provider type, time/date, amount, and/or the like, to compute the score. In some cases, the transport computer 220 configures parameters used by the clearing model 260 to generate the score. For example, the transport computer 220 configures parameters such as how different merchant category codes affect the score, cutoff threshold values, how the score relates to a merchant identifier, how the score relates to an acquirer identifier, and/or any other suitable data points.

As an example, for restaurants and hotels, due to tipping and/or other added charges, the amount submitted in the clearing draft is very likely to be different from the amount in the authorization request message, so the score will be low. On the other hand, for retail stores, the authorization and clearing amounts tend to match, so the score will be high. The acquirer can configure how to adjust the score for different resource provider indicators (e.g., merchant category code, MCC).

In some aspects, the processor server computer 230 and/or the clearing model 260 generates an indicator, indicating the determined likelihood that the interaction amount in the authorization request message will equal the clearing amount for the interaction. In some implementations, the indicator is the score generated by the clearing model 260. Alternatively, or additionally, the indicator indicates whether the score is above a threshold. For example, the score is a number between 0 and 100, 1-99, 1-10, or any other suitable range. In some instances, the transport computer 220 configures a desired threshold. The transport computer 220 may set the threshold value to 80 or 90 or any other suitable value.

At step S204, the processor server computer 230 generates and transmits a modified authorization response message comprising the indicator and the indication of approval. The processor server computer 230 may modify the received authorization response message to include the indicator. The processor server computer 230 may insert the indicator into a field of the modified authorization response message.

The processor server computer 230 may then transmit the modified authorization response message to the transport computer 220. The transport computer may then forward the modified authorization response message to the resource provider computer 210.

In some aspects, the processor server computer 230 further generates and includes in the authorization response message a table to carry the acquirer configuration details that will be used to identify participating acquirers. In some examples, the authorization system will check for acquirer participation (acquirer identifier, merchant category code/identifier) in the response leg of approved authorizations.

The processor server computer 230 transmits, to the resource provider computer 210, the modified authorization response message. In some aspects, the processor server computer 230 transmits the authorization response message to the transport computer 220. The transport computer 220 receives the authorization response message and forwards it to the resource provider computer 210.

In some aspects, the processor server computer 230 makes a determination whether to generate a clearing draft on behalf of the transport computer 220. If the score associated with the indicator is below the threshold value, then the processor server computer 230 does not generate a clearing draft, and clearing proceeds as described above with respect to FIG. 1. If the score associated with the indicator is equal to or greater than the threshold value, then the processor server proceeds to step S205. In some examples, the transactions with the high scores are treated as final amount known transactions, which means that the clearing amount should never change from the authorization amount. Accordingly, the processor server computer 230 can create a clearing draft for those transactions with a high score on the acquirer's behalf. In some aspects, based on the score exceeding the threshold, certain clearing activity may be bypassed for eligible transactions. Based on the indicator, the transport computer 220 may refrain from generating a clearing message. The indicator may indicate that the processor server computer 230 should generate the clearing draft on the behalf of the acquirer, in which case the transport computer 220 may refrain from doing so.

At step S205, the processor server computer 230 generates a clearing draft, also referred to as a clearing message or clearing record, using transaction details from the authorization request message and clearing model 260. In some aspects, the clearing message is generated based on the indicator and at least a subset of the interaction data. In some examples, the clearing message includes interaction data such as an account identifier. In some aspects, the clearing message includes authorization transaction details and the indicator, which will be passed to the authorization computer 240 and/or other computing devices in the system 200.

The clearing message may comprise data for the corresponding interaction such as a transaction code, an account number (e.g., a PAN), the date and time of the transaction, service provider identifiers (e.g., merchant name, merchant category code), authorization identifiers (e.g., an authorization code, an Auth TID), and a unique transaction identifier. The transaction code may indicate the type of clearing record. For example, if the transaction code is 05, it may indicate that the clearing record is for a sales draft, whereas if the transaction code is 25, it may indicate that the clearing record is for a sales draft reversal. The authorization code may be from the authorization response message and prove that the authorization computer 240 previously authorized the transaction. The clearing record may further include a unique transaction identifier, which can be from the corresponding authorization records. The unique transaction identifier can thus be used to match the clearing record to its authorization.

At step S206, the processor server computer 230 transmits the clearing message to the authorization computer 240 and/or the transport computer 220, thereby causing the clearing and settlement of the interaction. The processor server computer 230 routes the clearing message to the appropriate authorization computer 240. For example, the processor server computer 230 may route the clearing message based on the authorizing entity of the account that initiated the transaction. The authorization computer 240 may receive clearing records for the transactions that were initiated by accounts held with the authorization computer 240.

In some instances, at step S206, the processor server computer 230 transmits a clearing notification to the transport computer 220. The clearing notification may include similar information as is contained in the clearing message. In some aspects, the transport computer 220 stores a record indicating that the clearing of the interaction is being expedited (e.g., to avoid double clearing).

Thus, in some aspects, the processor server computer 230 transmits the clearing message directly to the authorization computer 240 (i.e., the processor server computer 230 may submit the clearing draft on behalf of the acquirer). This can streamline and reduce the processing required, as the transport computer 220 can be left out of this phase of processing the interaction. In such cases, the clearing notification may be provided to the transport computer 220 for record keeping and/or training purposes.

Alternatively, or additionally, the transport computer 220 may be involved in submitting the clearing message. For example, the processor server computer 230 transmits the clearing message to the transport computer 220 at step 206. In some aspects, the transport computer 220 forwards the clearing message to the authorization computer 240. In some aspects, the transport computer 220 is involved so that the acquirer can continue to have the full record of the history of the merchant behavior on an ongoing basis and can help train the clearing model 260.

In some aspects, the processor server computer 230 (and/or transport computer 220) submits the clearing draft within a day, an hour, a minute, a second, or instantly after the processor server computer 230 transmits the modified authorization response message. Thus, clearing can be performed substantially faster than in traditional methods using the techniques described herein.

In some instances, when the authorization computer 240 receives a clearing message, it posts the interaction details to the respective account and removes any previous holds. For example, based on the clearing message, the authorization computer 240 may identify the original matching authorization, drop the pending authorization, and officially post the transaction to the user's account. This is when the final charge shows up on the user's statement.

To match a clearing record to the original authorization, the authorization computer 240 may search for authorization records with the same identifiers (e.g., a unique transaction identifier, or an authorization code) as the clearing message.

The processor server computer 230 may further facilitate a settlement process to move funds between the authorization computer 240 and the transport computer 220.

At step S207, the processor server computer 230 transmits a settlement message to the authorization computer 240 and the settlement agent 250. In some aspects, the settlement reporting is delivered to both the transport computer 220 and the authorization computer 240 in the same clearing cycle. In some aspects, the processor server computer 230 and/or transport computer 220 creates settlement records that are passed on for reporting. Thus, settlement reporting can be done on the acquirer side according to various aspects.

At step S208, funding is performed. The funds for the interaction are transmitted from the authorization computer 240 to the transport computer 220.

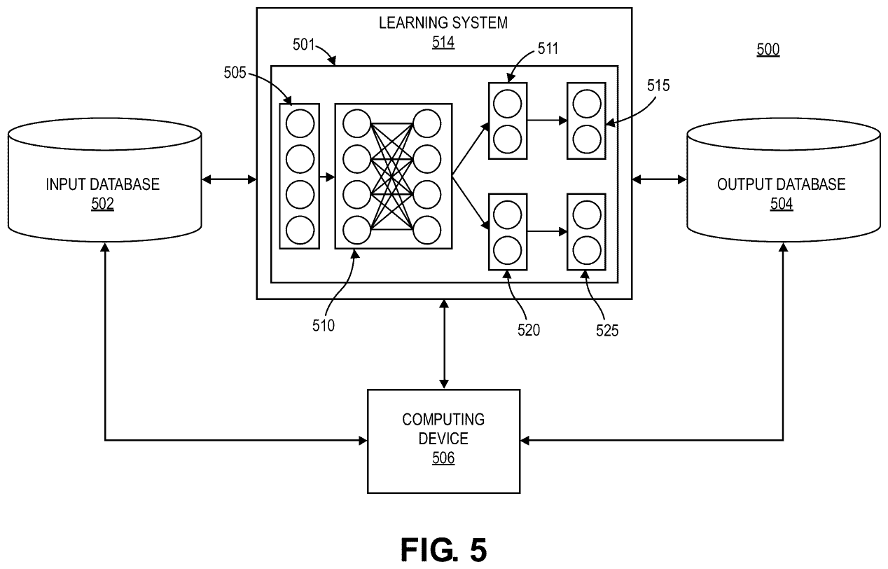

At step S209, interaction information is transmitted to the clearing model for future training. The transport computer 220 and/or processor server computer 230 may transmit the interaction information to the clearing model. The interaction information may, for example, indicate whether the clearing amount indeed matched the authorization amount. In some examples, the interaction information includes other data such as the final amount, settlement and/or clearing details, and/or the like. In some aspects, at an initial time and/or periodically, the machine learning model(s) are trained. For example, as additional interaction information is obtained, the model is updated through a retraining or fine-tuning process. Information indicating whether the cleared and authorized amounts match may be fed to the clearing model 260 for training. Examples of models and training techniques that can be applied are described in further detail below with respect to FIG. 5.

The techniques provided herein speed up the clearing process by having the processor server computer create clearing drafts on behalf of the acquirer so that the clearing drafts can be delivered to the issuer faster. The whole process is sped up by eliminating the acquirer's need to create and/or submit a clearing draft. Those interactions with scores above the threshold can be cleared faster, since typically the acquirer submits clearing drafts later in the day or the next day, which can be outside of the current settlement cycle. With the techniques described herein, with assurance that the clearing amount will equal the settlement amount, the clearing message is sent immediately and will be included in the current settlement cycle. This delivers immediacy to parties-acquirer, issuer, and cardholder. Accordingly, the techniques described herein improve the speed and efficiency of interaction processing.

The techniques provided herein further eliminate the data integrity issues that causes matching issues for issuers. For example, if the issuer system has a sufficiently high degree of certainty that a transaction can be posted early (e.g., at the time of receiving the authorization request, before receiving the clearing message, and/or the like), posting the transaction may improve the consumer's experience (e.g., reduce confusion, frustration, etc.), improve accuracy (e.g., of the balance and/or available funds of the consumer's account), improve transparency, reduce or eliminate delays, and reduce inconsistencies.

FIG. 3 illustrates an example of a processor server computer 300, according to some embodiments. The processor server computer 300 may be part of the system 200 depicted in FIG. 2 (e.g., processor server computer 230). The processor server computer 300 may include a processor 304 operatively coupled to a memory 306, a network interface 302, and a computer-readable medium 308. The processor server computer 300 may include more components, or fewer components, than illustrated in this example.

The processor 304 may be implemented as one or more integrated circuits (e.g., one or more single core or multicore microprocessors and/or microcontrollers). The processor 304 may be used to control the operation of the processor server computer 300. The processor 304 can execute a variety of programs in response to program code or computer-readable code stored in memory. The processor 304 may include functionality to maintain multiple concurrently executing programs or processes.

The memory 306 may be implemented using any combination of any number of non-volatile memories (e.g., flash memory) and volatile memories (e.g., DRAM, SRAM), or any other non-transitory storage medium, or a combination of media.

The computer-readable medium 308 may comprise one or more non-transitory media for storage and/or transmission. Suitable media include, as examples, a random access memory (RAM), a read only memory (ROM), a magnetic medium such as a hard-drive or a floppy disk, or an optical medium such as a compact disk (CD) or DVD (digital versatile disk), flash memory, and the like. The computer-readable medium 308 may be any combination of such storage or transmission devices. The computer-readable medium 208 may comprise software code stored as a series of instructions or commands. In some aspects, the code stored by the computer-readable medium 308 includes a communication module 310, a participation management module 312, and a processing module 314. The processor server computer may optionally include a learning module 316, clearing model 318, and historical database(s) 320.

In some embodiments, the computer-readable medium 308 includes code for causing the processor 304 to perform a method comprising receiving, by a processor server computer from a transport computer, an authorization request message for an interaction, the authorization request message comprising interaction data comprising an interaction amount; transmitting, by the processor server computer, the authorization request message to an authorization computer; receiving, by the processor server computer from the authorization computer, an authorization response message indicating that the interaction is approved; based on the interaction data, generating, by the processor server computer, an indicator, wherein the indicator indicates a likelihood that the interaction amount in the authorization request message will equal a clearing amount for the interaction; generating, by the processor server computer, a modified authorization response message comprising the indicator; transmitting, by the processor server computer to the transport computer, the modified authorization response message; generating, by the processor server computer, a clearing message based on the indicator and at least a subset of the interaction data; and transmitting, by the processor server computer to the authorization computer or the transport computer, the clearing message, thereby causing clearing and settlement of the interaction.

In some embodiments, the communication module 310 may comprise code that causes the processor 304 to generate messages, forward messages, reformat messages, and/or otherwise communicate with other entities.

In some embodiments, the participation management module 312 includes instructions which, when executed by the processor 304, cause the performance of operations for determining how to process an interaction based on acquirer configuration details. Acquirers may opt in or out of the specialized clearing scheme described herein, e.g., based on factors such as merchant identifier, MCC, acquirer identifier and/or the like. The processor server computer 300 may store a table including the acquirer configuration details used to identify participating acquirers. The participation management module 312 may traverse the stored table to determine whether a particular interaction should be processed according to the specialized clearing scheme or not, and process the interaction accordingly.

In some embodiments, the processing module 314 includes instructions which, when executed by the processor 304, cause the performance of operations for processing an interaction. The processing module 314 may include code configured to identify appropriate computers for receiving interaction requests and responses. The processing module 314 may include functionality to deliver authorization services, exception file services, and clearing and settlement services. In some aspects, the clearing services performed by the processing module 314 include generating a clearing message on behalf of the acquirer, as described herein. The processing module 314 may further include functionality to incorporate information generated by the clearing model 318 in order to determine whether to generate the clearing message, as described herein.

In some embodiments, the learning module 316 includes functionality to train and update the clearing model 318. The learning module may use data associated with prior transactions, stored in the historical database(s) 320, to train and/or update the clearing model 318. The learning module 316 and historical database(s) 320 may be similar to the learning system 514, input database 502, and output database 504, described below with respect to FIG. 5.

In some embodiments, the clearing model 318 includes one or more machine learning models configured to predict whether the interaction amount in the authorization request message will equal a clearing amount for the interaction, as described herein. The clearing model 318 may be similar to the clearing model 501 described below with respect to FIG. 5.

FIG. 4 illustrates an example of a transport computer 400, according to some embodiments. The transport computer 400 may be part of the system 200 depicted in FIG. 2 (e.g., transport computer 220). The transport computer 400 may include a processor 404 operatively coupled to a memory 406, a network interface 402, and a computer-readable medium 408. The transport computer 400 may include more components, or fewer components, than illustrated in this example.

The processor 404, memory 406, network interface 402, and computer-readable medium 408 may be similar to the processor 304, memory 306, network interface 302, and computer-readable medium 308 described above with respect to FIG. 3. The computer-readable medium 408 may include a communication module 410, a configuration management module 412, and a clearing and settlement module 414.

In some embodiments, the computer-readable medium 408 includes code for causing the processor 404 to perform a method comprising receiving, by the transport computer from the processor server computer, an authorization response message indicating that the interaction is approved, the authorization response message further comprising an indicator, generated using a machine learning model, which indicates a likelihood that the interaction amount in the authorization request message will equal a clearing amount for the interaction; receiving, by the transport computer, a clearing notification based on the indicator and at least a subset of the interaction data; and transmitting, by the transport computer to a computing device, at least a subset clearing message, thereby causing updating of the machine learning model.

In some embodiments, the communication module 410 may comprise code that causes the processor 404 to generate messages, forward messages, reformat messages, and/or otherwise communicate with other entities.

In some embodiments, the configuration management module 412 may comprise code that causes the processor 404 to establish configuration parameters for interaction processing preferences. The configuration management module 412 can include functionality to configure factors used to establish participation in the specialized clearing techniques described herein. Alternatively, or additionally, the configuration management module 412 can include functionality to establish a cut-off score for determining whether to apply the specialized clearing techniques described herein.

In some embodiments, the clearing and settlement module 414 may comprise code that causes the processor 404 to perform clearing and/or settlement services. After sending payment confirmation, the clearing and settlement module 414 may comprise code that causes the processor 404 to clear and/or settle funds between the transport computer and the authorization computer.

FIG. 5 illustrates an example of systems and techniques 500 for training and applying a clearing model 501, according to various embodiments. As shown in FIG. 5, the system may include an input database 502, an output database 504, a computing device 506, and a learning system 514. The learning system 514 may be part of the processor server computer described above, or part of an external computer communicatively coupled to the processor server computer.

In some embodiments, the learning system 514 includes a clearing model 501 (e.g., the clearing model 260 described above). In some aspects, the clearing model 501 includes one or more machine learning models. In some aspects, the clearing model includes a neural network that includes a plurality of layers including an input layer, at least one hidden layer (e.g., a plurality of hidden layers), and at least one output layer. In some examples, the clearing model 501 is or includes a neural network such as a DNN.

In some implementations, the clearing model 501 is or includes at least one MTL model. In some aspects, the MTL model may be configured to perform multiple tasks (e.g., a first task, a second task, a third task, etc.). For MTL, at least some of the hidden layers (and/or the input layer) of the machine learning model may be shared between multiple tasks, and each task may have associated therewith at least one output layer (e.g., separate from the output layer(s) of other tasks). For example, sharing layers may include hard parameter sharing (HPS) and/or other suitable techniques.

In some aspects, the first task may include generating a first prediction associated with a likelihood that the interaction amount in the authorization request message will equal a clearing amount for the interaction. The first prediction may include a first score. Additional tasks may include generating a second prediction associated with when the clearing message will be received after the authorization message and/or generating a third prediction associated with the number of clearing messages that will be received.

In some aspects, the clearing model 501 includes an input layer 505, one or more shared hidden layers 510, one or more first task hidden layers 511, first output layer 515, one or more second task hidden layers 520, and one or more second output layers 525. In some aspects, shared hidden layer(s) 510 may be associated with multiple tasks (e.g., both a first task and a second task). In some aspects, the first task hidden layer(s) 511 may be associated with the first task, and the first output layer 515 may be associated with the first task. In some aspects, the second task hidden layer(s) 520 may be associated with the second task(s), and the second output layer(s) 525 may be associated with the second task(s). For example, if the MTL model performs three tasks, the at least one second task may include two “second” tasks (e.g., which could be referred to as a second task and a third task), and the MTL would include two sets of second task hidden layers 520 (e.g., one for the second task and one of the third task) and two second output layers 525 (e.g., one for the second task and one of the third task). In alternative implementations, one task may be performed, and additional task layers can be omitted. In such implementations, where the clearing model 501 may not have shared hidden layers between tasks.

In some embodiments, the clearing model 501 includes a plurality of hidden layers associated with one or more tasks. The clearing model 501 may include one or more output layers associated with one or more tasks The learning system 514 may communicate with the input database 502, the output database 504, and/or the computing device 506.

In some embodiments, the input database 502 may include a plurality of training data items and/or a plurality of testing data items for the learning system 514. In some aspects, each data item may include a plurality of elements, and each element may be associated with a respective feature of a plurality of features. In some aspects, the learning system 514 may use the data items from input database 502 as input to the clearing model. For example, the learning system 514 may use the testing data items as input to the clearing model for testing and evaluation of the clearing model. In some aspects, the input database 502 and/or the learning system 514 may receive the data items (e.g., training and/or testing data items) from the computing device 506.

In some embodiments, input database 502 may include new testing data that has not been previously seen by (e.g., input to, processed by) the learning system 514. In some non-limiting embodiments or aspects, the data items from input database 502 may be input to the learning system 514 to evaluate the performance of the clearing model. The testing data items from input database 502 may be input to the learning system 514 to evaluate the performance of the first task associated with the clearing model. In implementations using an MTL model, the testing data items from input database 502 may be further input to the learning system 514 to evaluate the individual performance of the second task and/or any additional tasks associated with the clearing model.

In some aspects, the output database 504 may include information characterizing features of the clearing model. Such information can include one or more feature scores, one or more groupings, one or more overall accuracy scores, one or more task accuracy scores, one or more adjusted feature scores, one or more impact scores, one or more groups of features, one or more predictions, and/or the like, as described herein. For example, the output database 504 may receive these outputs from the learning system 514. In some aspects, the learning system 514 and/or output database 504 may communicate such outputs to the computing device 506.

In some aspects, the computing device 506 is a device that gathers and provides information about historical interactions. For example, the computing device 506 may include the aforementioned processor server computer 230, transport computer 220, authorization computer 240 and/or the like. The computing device 506 may be in communication with input database 502, output database 504, and/or learning system 514.

In some embodiments, the learning system 514 may receive data items from input database 502 as input to the clearing model 501. The learning system 514 may produce outputs, as described herein, which may be communicated to and/or stored in output database 504. The learning system 514 may communicate output data to one or more other systems (e.g., the computing device 506 and/or the like).

At an initial time and/or periodically, the clearing model 501 is trained. Training the clearing model 501 may include gathering appropriate training data, which may be labeled and/or unlabeled. The training data may, for example, include historical transaction data, which may be labeled to indicate whether the clearing amount and ultimate authorization amount match. The training data is provided to the clearing model 501. Output from the clearing model 501 is obtained. The output is compared to the training data. The learning system 514 may update the parameters of the clearing model 501 on the comparison.

In some examples, the clearing model 501 includes one or more neural networks. The learning system 514 trains the clearing model 501 using backpropagation. For example, clearing model 501 receives training data as input and outputs a predicted result. This result is compared to the label assigned to that training data. In some implementations, the comparison is performed by determining gradients based on the input and predicted result (e.g., by minimizing a loss function by computing and minimizing a loss value representing an error between the predicted result and the actual label value). The computed gradient is then used to update the parameters of the neural network.

The training process may include determining one or more features associated with one or more tasks. The training process may further include determining accuracy scores for one or more tasks. For example, the learning system 514 may determine an overall accuracy score, a first task accuracy score, a second task accuracy score, etc. In some aspects, the learning system 514 may determine accuracy scores based on inputting the testing data set to the clearing model 501. The learning system 514 may determine accuracy scores based on training the clearing model 501 with the training data on the first task. In some implementations, the clearing model 501 is further trained on additional tasks (e.g., a second task, a third task, etc.). The learning system inputs the testing data to generate one or more accuracy scores. For example, the learning system 514 may train the clearing model 501 on both the first task and one or more additional tasks by sharing hidden layers between the tasks.

In some aspects, the training process may include applying feature reduction evaluation (FRE). For example, the learning system 514 may apply FRE to provide a feature score for each feature in the testing data set. Applying FRE may include removing a feature (e.g., replacing the element associated with the feature of each testing data item with a constant default value, such as 0, 1, the average value of elements associated with that feature among the testing data items, and/or the like. Applying FRE may further include inputting the testing data items (with the feature removed) to the clearing model 501, and determining a performance score (e.g., F score, F1 score, accuracy, and/or the like) for the first task (e.g., a first task performance score). In implementations with MTL, this may further include determining a performance score for each of one or more additional tasks (e.g., a second task performance scores for a second task, etc.) and/or overall performance (e.g., an overall performance score). This may be repeated for each feature. In some aspects, the feature score for each respective feature may be determined based on the performance score (e.g., first, second, and/or overall performance score) associated with the respective feature. As an example, an F1 score may be subtracted from 1 to provide a respective feature score.

In some aspects, the training process may include adjusting feature scores. For example, the learning system 514 may adjust the feature score of each respective feature based on a respective grouping of a plurality of groupings associated with the respective feature. Additionally or alternatively, the feature score of each respective feature may be adjusted based on at least one of the overall accuracy scores, the first task accuracy score, the at least one second task accuracy score, any combination thereof, and/or the like to provide an adjusted feature score for the respective feature.

In some aspects, a subset of the plurality of features may be selected based on the adjusted feature score for each respective feature of the plurality of features. Additionally, or alternatively, a second machine learning model may be trained based on the subset of the plurality of features. The adjusted feature score for each feature may be communicated to a remote computing device.

Any of the software components or functions described in this application may be implemented as software code to be executed by a processor using any suitable computer language such as, for example, Java, C, C++, C#, Objective-C, Swift, or scripting languages such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a processor server computer from a transport computer, an authorization request message for an interaction, the authorization request message comprising interaction data comprising an interaction amount;
transmitting, by the processor server computer, the authorization request message to an authorization computer;
receiving, by the processor server computer from the authorization computer, an authorization response message indicating that the interaction is approved;
based on the interaction data, generating, by the processor server computer, an indicator, wherein the indicator indicates a likelihood that the interaction amount in the authorization request message will equal a clearing amount for the interaction;
generating, by the processor server computer, a modified authorization response message comprising the indicator;
transmitting, by the processor server computer to the transport computer, the modified authorization response message;
generating, by the processor server computer, a clearing message based on the indicator and at least a subset of the interaction data; and
transmitting, by the processor server computer to the authorization computer or the transport computer, the clearing message, thereby causing clearing and settlement of the interaction.

2. The method of claim 1, wherein the clearing of the interaction is performed in less than an hour from transmitting the modified authorization response message.

3. The method of claim 1, wherein the indicator is generated using a machine learning model trained to predict the likelihood that the interaction amount in the authorization request message will equal the clearing amount for the interaction.

4. The method of claim 3, further comprising:
training the machine learning model using historical interaction data.

5. The method of claim 3, wherein:
the machine learning model comprises a multi-task learning model having a plurality of layers.

6. The method of claim 1, wherein the processor server computer transmits the clearing message to both the authorization computer and the transport computer.

7. The method of claim 1, further comprising:
determining, based on the interaction data, that the transport computer is enrolled in a program before generating the indicator, wherein generating the indicator, generating the modified authorization response message comprising the indicator, and generating and transmitting the clearing message are performed responsive to determining the enrollment.

8. A processor server computer comprising:
one or more processors; and
one or more computer readable media comprising code executable by the one or more processors to perform a method comprising:
transmitting an authorization request message for an interaction to an authorizing computer, the authorization request message comprising interaction data comprising an interaction amount;
receiving, from the authorizing computer, an authorization response message indicating that the interaction is approved;
based on the interaction data, generating an indicator, wherein the indicator indicates a likelihood that the interaction amount in the authorization request message will equal a clearing amount for the interaction;
generating a modified authorization response message comprising the indicator;
transmitting the modified authorization response message;
generating a clearing message based on the indicator and at least a subset of the interaction data; and
transmitting, to the authorization computer or a transport computer, the clearing message, thereby causing clearing and settlement of the interaction.

9. The processor server computer of claim 8, the method further comprising:
receiving the authorization request message from the transport computer prior to transmitting it to the authorizing computer.

10. The processor server computer of claim 8, wherein the clearing of the interaction is performed in less than an hour from transmitting the modified authorization response message.

11. The processor server computer of claim 8, wherein the indicator is generated using a machine learning model trained to predict the likelihood that the interaction amount in the authorization request message will equal the clearing amount for the interaction.

12. The processor server computer of claim 11, the method further comprising:
training the machine learning model using historical interaction data.

13. The processor server computer of claim 11, wherein:
the machine learning model comprises a multi-task learning model having a plurality of layers.

14. The processor server computer of claim 8, the method further comprising:
determining, based on the interaction data and a stored table, that the transport computer is enrolled in a program before generating the indicator, wherein generating the indicator, generating the modified authorization response message comprising the indicator, and generating and transmitting the clearing message are performed responsive to determining the enrollment.

15. A method comprising:
transmitting, by a transport computer to a processor server computer, an authorization request message for an interaction, the authorization request message comprising interaction data comprising an interaction amount;
receiving, by the transport computer from the processor server computer, an authorization response message indicating that the interaction is approved, the authorization response message further comprising an indicator, generated using a machine learning model, which indicates a likelihood that the interaction amount in the authorization request message will equal a clearing amount for the interaction;
receiving, by the transport computer, a clearing notification based on the indicator and at least a subset of the interaction data; and
transmitting, by the transport computer to a computing device, at least a subset of the clearing notification, thereby causing updating of the machine learning model.

16. The method of claim 15, wherein the interaction is thereafter cleared in less than an hour from receiving the authorization response message.

17. The method of claim 15, wherein the machine learning model is a neural network trained to predict the likelihood that the interaction amount in the authorization request message will equal the clearing amount for the interaction.

18. The method of claim 15, further comprising:
refraining from generating the clearing message based on the indicator.

19. The method of claim 18, wherein the processor server computer generates the clearing message based on the indicator.

20. The method of claim 15, further comprising:
providing, to the processor server computer, configuration data configuring enrollment in a program, wherein
receiving the indicator and generating the clearing message based on the indicator and at least a subset of the interaction data are performed responsive to providing the configuration data.
